(19) United States
(12) Patent Application Publication
(10) Pub. No.: US 2019/0197569 A1
(43) Pub. Date: Jun. 27, 2019

(54) OPTIMIZATION METHOD AND SYSTEM OF MATCHING PRODUCT EXPERIENCING ACTIVITY WITH PARTICIPANTS

(71) Applicant: NATIONAL TSING HUA UNIVERSITY, HSINCHU (TW)

(72) Inventors: CHEN-FU CHIEN, HSINCHU (TW); KUO-YI LIN, Taichung City (TW)

(21) Appl. No.: 15/928,062

(22) Filed: Mar. 21, 2018

(30) Foreign Application Priority Data
Dec. 27, 2017 (TW) 106145994

(51) Int. Cl. G06Q 30/02

(52) U.S. Cl. CPC G06Q 30/0204; G06Q 30/0203

(57) ABSTRACT

An optimization method and system of matching a product experiencing activity with participants are disclosed. The method comprises the following steps: storing, in a memory, personal information of the applicants collected by conducting an investigation with questionnaires; clustering the personal information of the applicants to form a plurality of characteristic sample groups; evaluating a weight value of each of the applicants in each of the plurality of characteristic sample groups to produce a representative for each of the plurality of characteristic sample groups in accordance with the weight values; selecting a plurality of candidates to participate the experiencing activity in coordination with the characteristic sample groups and the representative according to an activity restriction of the experiencing activity; and notifying the candidates to participate the experiencing activity.

### CROSS-REFERENCE TO RELATED APPLICATION

This application claims priority from Taiwan Application No. 106145994, filed on Dec. 27, 2017, in the Taiwan Intellectual Property Office, the content of which is hereby incorporated by reference in their entirety for all purposes.

### BACKGROUND OF THE INVENTION

### Field of the Invention

The present invention relates to an optimization method and system of matching product experiencing activity with participants, and particularly relates to a method and system of clustering random participants and finding the most suitable and representative participants for product experiencing activities through evaluation and selection.

### Description of the Related Art

For the technological and electronic industry, when new products are developed, whether for innovative products or for improvements of existing products, the target markets or target customers need to be analyzed so as to make the selected products meet the needs of customers. In this process, many enterprises experiment with actual experience of products on users in the product development phase. After actually experiencing the product, the participants generate feedback in the form of opinions and advice. These enterprises further decide whether or not the product design fits the customers' needs, or whether or not some adjustment on the product is needed or who the objects of the product marketing are, all of these decisions are made according to the feedback presented.

At present, most of the participants who take the trials provided by the enterprises participate in the trials free or are randomly selected. Even though the backgrounds, characteristics, habits and so on of the participants are analyzed and interpreted after the participants actually experience the trials, the trial results cannot be extended to all aspects of consumers frequently due to the limited number of participants. Thus, the analysis of such product experiencing activities may be sufficiently representative. Consequently, it will be a very important part to collect feedback of various kinds of consumers and further provide enough information for the sequential development process in the new product development phase under limited resource and experience environment.

Summarizing the foregoing description, whether or not the participants are representative in the matching process has not been taken into account in the well-known experiencing activity. Consequently, the inventor of this invention has thought out and designed an optimization method and system of matching a product experiencing activity with participants so as to improve the prior art having some shortcomings and to benefit the industrial implementation.

### SUMMARY OF THE INVENTION

In view of the aforementioned problems of the prior art, one objective of the present invention provides an optimization method and system of matching a product experiencing activity with participants in order to solve the lack of representative step of the participants in the well-known experiencing activities.

In accordance with one objective of the present disclosure, an optimization method of matching a product experiencing activity with participants is provided. The optimization method is suitable for planning an experiencing activity in the product development phase. The optimization method of matching the experiencing activity and participants includes the following steps: storing, in a memory, personal information of a plurality of applicants collected by conducting an investigation with questionnaires; performing a clustering process through a processor, clustering the personal information of the plurality of applicants to for a plurality of characteristic sample groups and classifying each of the plurality of applicants according to the plurality of characteristic sample groups; performing, by the processor, an evaluation process, evaluating a weight value of each of the plurality of applicants in each of the plurality of characteristic sample groups, and producing a representative for each of the plurality of characteristic sample groups in accordance with the weight values; performing, by the processor, a sifting process selecting a plurality of candidates to participate the experiencing activity in accordance with the characteristic sample groups and the representative according to an activity restriction of the experiencing activity; and notifying, by the processor, the candidates to participate the experiencing activity.

Preferably, the personal information may comprise background information, lifestyle or aptitude surveys of the plurality of applicants.

Preferably, the clustering process may make use of K-Means clustering algorithm to cluster the personal information.

Preferably, the evaluation process may compute the degree of correlation between the personal information of the plurality of applicants and characteristics defined in the characteristic sample groups in order to provide the corresponding weight value.

Preferably, the activity restriction may include the number of the participants who experience the experiencing activity, the duration of the experiencing activity, the site of the experiencing activity and the cost of the experiencing activity.

In accordance with one objective of the invention, a system of matching a product experiencing activity and participants is provided. The system is suitable for planning an experiencing activity in a product development phase, the system comprising: an input interface, a memory, a processor and an output interface, wherein the input interface collecting personal information of a plurality of applicants investigated with questionnaires; the memory connects to the input interface and stores the personal information; the processor connects to the memory and accessing the memory to conduct a clustering process, an evaluation process and a sifting process. The clustering process clusters the personal information of the plurality of applicants to form a plurality of characteristic sample groups and classifies each of the plurality of applicants according to the plurality of characteristic sample groups; the evaluation process evaluates a weight value of each of the plurality of applicants in each of the plurality of characteristic sample groups and produces a representative for each of the plurality of characteristic sample groups in accordance with the weight values; and the sifting process selecting a plurality of candidates to participate the experiencing activity in accordance with the characteristic sample groups and the representative according to an activity restriction of the experiencing activity. The output interface outputs the matching result of the plurality of applicants.

Preferably, the personal information may comprise background information, lifestyle or aptitude surveys of the plurality of applicants.

Preferably, the cluster process may make use of K-Means clustering algorithm to cluster the personal information.

Preferably, the evaluation process may compute the degree of correlation between the personal information of the plurality of applicants and characteristics defined in the characteristic sample groups in order to provide the corresponding weight value.

Preferably, the activity restriction may include the number of the participants who experience the experiencing activity, the duration of the experiencing activity, the site of the experiencing activity and the cost of the experiencing activity.

As the foregoing description, the optimization method and system of matching an experiencing activity and participants according to the present invention may have one or multiple advantages described below:

1. The optimization method and system of matching an experiencing activity and participants may suit the product experiencing activities in the development phase of various new products. Take the experience feedback of the participants who actually operate the product as the basis for product improvement or marketing object determination in order to improve the chance of success of the new product development.

2. The optimization method and system of matching an experiencing activity and participants may cluster the users who randomly participate the activity in the characteristic sample manner such that the participants of the experiencing activity are taken from multiple characteristic samples in order to evaluate the experience feedback of various kinds of users and obtain the maximum evaluation efficiency from the trial with the limited number of participants.

3. The optimization method and system of matching an experiencing activity and participants may evaluate the representative degree of the participants for different characteristic samples such that the participants of the product experiencing activity are sufficiently representatively. The number of the participants who participate the trial may be reduced so as to reduce the development cost.

### BRIEF DESCRIPTION OF THE DRAWINGS

FIG. 1 depicts a flow chart of a commercial electronic product trial according to an embodiment of the present disclosure.

FIG. 2 depicts a flow chart of an optimization method of matching the product experiencing activity and participants according to an embodiment of the present disclosure.

FIG. 3 depicts a block diagram of a system of matching the product experiencing activity and participants according to an embodiment of the present disclosure.

### DETAILED DESCRIPTION OF THE PREFERRED EMBODIMENTS

In order to provide understanding of the technical features, the content, the advantages and the achievable performance of the present disclosure, the present disclosure are presented through embodiments described below in detail in accordance with the accompanying drawings. The accompanying drawings are intended to illustrate and assist the specification and do not present the actual ratio and the precise configuration. Consequently, the ratio and the configuration relationship in the accompanying drawings should not be interpreted to limit the scope of claims of the present disclosure.

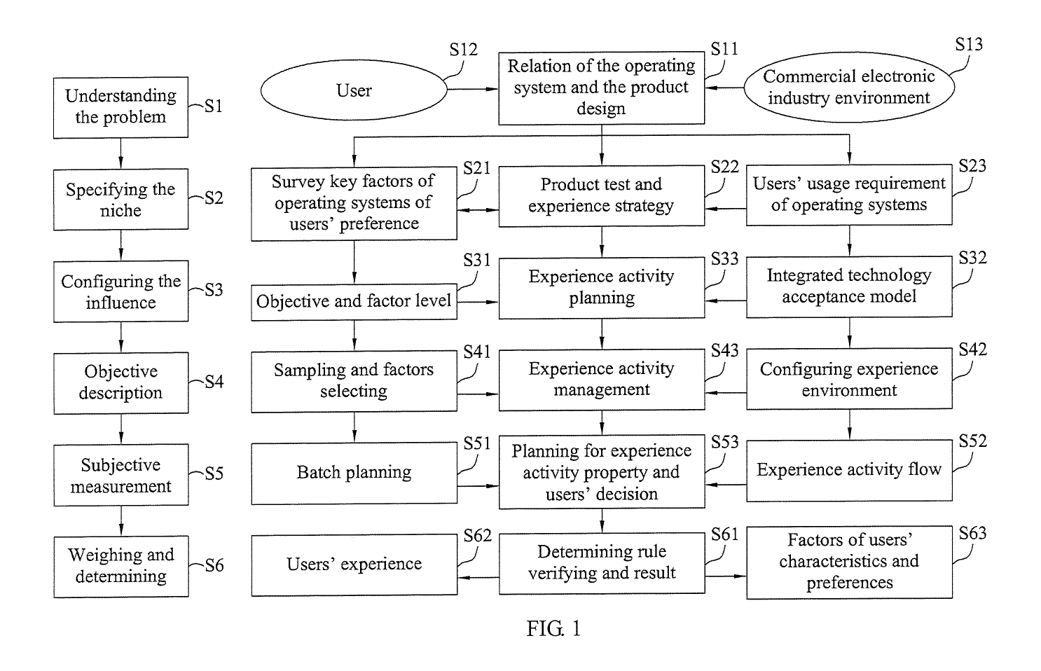

Referring to FIG. 1, which depicts a flow chart of a commercial electronic product trial according to an embodiment of the present disclosure. Take the commercial electronic products manufactured by the electronic vendors as an example. It is necessary to test the direction of development and adjustment of the product through the experiencing activity in which the consumers may actually operate the product. The following steps (S1˜S6), as shown in FIG. 1, are applied to proceed with the foregoing test:

Step S1: understanding the problem. Commercial electronic vendors provide brand companies with product research or service innovative concepts. In addition, hardware, mechanism designs and customers' responses to the product on the market are also provided so as to help the brand companies sell commercial electronic products having marketing potential. If the number of sold products is less than the expected number, the vendors have to pay the cost for unsalable products in their business model. Consequently, it is necessary to find out the product characteristics which meet the customers' expectation in order to select and design proper products and avoid the risk of unsalable situations. In order to achieve the goal, commercial electronic vendors have to specify which problems need to be test. In the present embodiment, the relation between the operating system and the product design in sub-step S11 is taken as the tested problem. The commercial electronic products with different operating systems such as tablet computers with Windows, iOS, Android and so on are taken as an example. However, the present disclosure should not be limited to this. The commercial electronic products may be personal computers or notebooks with different operating systems.

The forgoing problem is mainly discussed in two aspects S12 and S13. Sub-step S12 refers to users of the commercial products and sub-step S13 refers to different commercial electronic industry environment. Under the competition of different operating systems of the related industries, the operating systems are directly related to usage of the products by the users and decide the characteristics, the performance level and the interface of the product. The operating systems connecting the user interface to the system elements would affect consumers' preference to the commercial electronic products. Therefore, after launching the commercial electronic products with the specific operating system, the commercial electronic vendors need to survey the customers' feeling, the market response, and the usage requirements of the operating system so as to extract users' experience, summarize important characteristics and preference facts of the users, and assist surveying on the characteristics and facts that the users pay attention to. Consequently, the vendors may figure out the selling points and the target groups of each operating system so as to assist product promotion and design decisions. In the present embodiment, product promotion and design decisions may comprise the following elements, as shown in Table 1.

TABLE 1

| | Decision | |
|---|---|---|
| Type | element | Check results |
| Environment | Customer | Operating systems are an important factor when customers |
| | | experience commercial electronic products. Good experience |
| | | makes the users love the related series of products, share good |
| | | experience to others and further affect surrounding users' |
| | | perspective. Conversely, bad experience also affects surrounding |
| | | users' perspective and cause negative impression. |
| | Competitor | Take the tablet computer as an example. The operating systems |
| | | in the market are iOS, Android and Windows. Each vendor |
| | | continuously launches tablet products with new versions of the |
| | | operating systems in order to increase the market share. |
| | | However, there are various design directions of operating |
| | | systems. Only the designers understanding uses' requirement |
| | | may design products fitting users' preference. |
| | Industry | When new versions of the operating systems are released, |
| | | functions may simultaneously be expanded for upgrades so as to |
| | | motivate renewals and upgrades of commercial electronic |
| | | products. |
| Restriction | Cost | Upper limit of the cost. |
| | Time | Must operate in coordination with the product launch time. |
| | Other auxiliary | Experience equipment, experience sharing from industry experts |
| | resources | and discussion of research. |
| Related | Designer and | The designers are experts of the industry. The experiencing |
| people | Experiment | activities are designed according to the experience sharing from |
| | team | the experiment teams so as to evaluate users' feeling and look |
| | | for important factors which affect users' decision. Take users' |
| | | feeling and those important factors as reference for the |
| | | subsequent design. |
| | User | Consider the characteristics of users and survey uses' feeling, |
| | | preference and reasons for the operating systems from different |
| | | kind of users. |
| | Marketing | Sum up the marketing guidelines of the market according to |
| | manager | users' characteristics and properties of the products. Enhance |
| | | product reputation and goodwill by launching ideal products for |
| | | key customers. |

Step S2: specifying the niche. The present embodiment comprises sub-step S21 (survey key factors of operating systems of users' preference). Understanding the operating system key factors may further explain reasons for the user-preferred operating system and benefit the requirement of satisfaction to the factors for subsequent products in advanced so as to improve users' satisfaction. Sub-step S22 is product test and experience strategy. The preset embodiment may integrate the test steps of design thinking such as scenario setting, brief description, and demonstration and guide users to proceed with the product experience and free exploration. Sub-step S23 is users' usage requirements of operating systems. Since Windows, Android and iOS may be shipped with different tablet computers, the prime tablet computers of the respective operating systems are experienced by users in the operating system evaluation and survey so as to reduce the influence of intrinsic difference between different tablet computers.

Step S3: configuring influence. The configuring influence step comprises sub-step S31 (objective and factor level), sub-step S32 (integrated technology acceptance model) and sub-step S33 (experiencing activity planning) Sub-step S31 (objective and factor level) comprises design factors, fixed factors, variable factors, controllable factors, uncontrollable factors and interference factors, as shown in Table 2.

TABLE 2

| Factors | Examples of factors |
|---|---|
| Design factors | Operating system (Windows, Android, iOS) and users' |
| | personal information (users' aesthetic centrality, |
| | gender, age, occupation, and education background) |
| Fixed factors | Experience way, time span of product experience and |
| | surveyed aspects of product experience |
| Variable factors | Individual differences of users |
| Controllable | The order in which users operate, the order in which |
| factors | users experience products and the date when users |
| | participate experiencing activities |
| Uncontrollable | Sounds which might occur in the experience process |
| factors | such as sounds of air conditionings and broadcasts |
| Interference | Power supply, temperature, humidity, sunlight and |
| factors | time span of product experience |

The users' aesthetic centrality mentioned above is an overall and important level of visually aesthetics between specific consumers and products and might affect the product aesthetic evaluation of customers. Since the user interface and the style thereof are one of the characteristics of the operating system, the users' aesthetic centrality may be divided into three aspects of value capacity, sensitivity and response capacity. The aspect of value capacity indicates that product aesthetics may improve the living levels of individuals and society. The aspect of sensitivity indicates the capacity for recognizing, classifying and evaluating product aesthetics. The aspect of response capacity indicates the response degree of consumers toward the design aesthetics of products.

In order to evaluate the requirement and satisfaction of users toward the operating system, the present embodiment may develop a questionnaire based on Unified Theory of Acceptance and Use of Technology (UTAUT) to evaluate the satisfaction of users toward the operating system. The aspects of the questionnaire may comprise performance prediction, cost prediction, society influence, required conditions, action willingness, and actual use wherein the performance prediction refers to the beneficial degree of using the operating system for jobs or leisure times, the cost prediction refers to the degree of required cost of using the operating system, the society influence refers to the degree of influence from others when users use the operating system, the required conditions refer to the support degree of using the operating system for personal PC products when taking the budget and the living habit into consideration, the action willingness refers to the willingness of customers for using and purchasing the operating system product, and actual use refers to the actual purchase action of customers for the operating system products.

The purpose of planning the experiencing activity is to make the users experience the product under the same foundation. Plan the required work and time span for users at certain particular time including entering the laboratory at the beginning of time, signing in, signing the consent form for experience, signing the confidentiality agreement, receiving the standard operating procedure list, experiencing the product, filling out the questionnaire, interviewing, and the final signing out and receiving of remuneration.

Step S4: objective description. The objective description step comprises sub-step S41 (sampling and factors selecting), sub-step S42 (configuring experience environment) and sub-step S43 (experiencing activity management). Sub-step S41 (sampling and factors selecting) may take the sample information such as gender (male or female), occupations (student, military, public servant, teaching and administrative staff, technology industry and financial industry), age, education background (education level and graduation department) and aesthetic centrality. However, the present disclosure is not limited to this. In order to evenly select users to experience the product and understand the experience feeling of users toward different operating systems, it is described in detail as how to optimize the select users in the subsequent embodiments.

Sub-step 42 (configuring experience environment) is to confer on the overall mechanism of the experiencing activity and to plan the traffic flow for users' experience such that the requirement of experience space and related assistant products may be evaluated in advance. The overall mechanism of the experiencing activity should take shape and size of the overall space, the position of columns, windows, safekeeping facilities, assistant facilities and products and the expected traffic flow for experience into consideration. The space condition may be evaluated in advance according to the space sketch. For example, place each of the operating system products in each experience region respectively such that users may operate various combinations of products according to the properties of the samples evenly distributed to the experience regions.

Sub-step S43: experiencing activity management. Practical commercial electronic products may have a high degree of confidentiality before being launched. The managers need to construct the product safekeeping mechanism and the product confidentiality mechanism in order to prevent the product from losing or prevent leakage of confidential information. The commercial electronic products which are experimented may be prevent form missing through access control, alarm mechanism, a single entrance and exit management, exit management and video, etc. In addition, the managers, assistants and users may also sign up the confidentiality contracts in the confidentiality mechanism.

Step S5: subjective measurement. The subjective measurement step comprises sub-step S51 (batch planning), sub-step S52 (experiencing activity flow) and sub-step S53 (planning for experiencing activity property and users' decision); wherein sub-step S51 (batch planning) and sub-step S52 (experiencing activity flow) are to arrange the number of participants and the number of times of experience according to the period of the experiment. For example, during the estimated period, arrange the time on which the participants may experience the experiment and the schedule of the experiencing activity. The number of participants in each batch of the experiencing activity may be determined according to the estimated time. The estimated time of the experiencing activity is set when the following two cases are both achieved: according to the project funding and time limitation of the experiencing activity and according to the test of participants in the experiencing activity.

Sub-step S53: planning for experiencing activity property and users' decision. In the present embodiment, the interaction between the users' purchase decision of the operating system and the characteristics of the users may be discussed according to the rough set theory; wherein the rough set theory may define the foregoing steps and preprocess the information so as to discuss the interaction between the users' background information and the operation feeling and purchase decision of the operating system. The present embodiment comprises a plurality of characteristics of users' conditions and a plurality of determination characteristics for determining whether to purchase or not. Then, divide the result of the experiencing activity into the training data set and the test data set. The training data set is used to produce rules and the test data set is used to test the accuracy of the rules produced from the training data set. Get important determination factors which affect the users according to the result of the rule production and the rule test.

The condition characteristics applied in the present embodiment may comprise the factor characteristics and confidence levels shown in Table 3. The confidence levels and gain values should also be subsequently used to judge whether the set rules are acceptable or not. Here, the threshold of the confidence level may be set to be 70% and the threshold of the gain values may be set to be 1. However, the present disclosure is not limited to this. All different thresholds of the factor characteristics and confidence levels may be adjusted according to the content of the experiencing activity in order to meet the actual situation; wherein the confidence level may be the ratio of the samples which meet the result of the rules among the samples which meet the rule situations.

TABLE 3

| Condition characteristics and determination characteristics | level |
|---|---|
| Gender: | 2 |
| Age: | 4 |
| Occupation: | 5 |
| What did you major in? | 5 |
| What is your monthly income range? | 4 |
| How much you can spend on your notebook/tablet every year? | 4 |
| How much time on average you spend on your notebook/tablet | 5 |
| every day? | |
| How many days per week you spend on your notebook on average? | 4 |
| How many days per week you spend on your tablet on average? | 4 |
| How many years have you used notebook/tablet? | 5 |
| Do you plan to purchase a desktop, notebook or tablet within 6 | 2 |
| months? | |
| Do new 3C products hold remarkably attraction for you? | 2 |
| Do you have a notebook? | 2 |
| Do you have a tablet? | 2 |
| Do you have a smart phone? | 2 |
| Have you downloaded Android App? | 2 |
| Have you downloaded Windows App? | 2 |
| Have you downloaded Apple App? | 2 |
| Have you used cloud hardware? | 2 |
| Personal aesthetic centrality: | 3 |
| Do you think that a lot of knowledge is needed for operating the | 7 |
| operating system? | |
| Do you think that the operating system holds high response speed? | 7 |
| Do you think that the operating system holds good operating | 7 |
| stability? | |
| Do you thing that the operating system has simple operating steps? | 7 |
| Do you think that the operating system consumes little energy? | 7 |
| Do you think that the operating system has a good brand image? | 7 |
| Do you think that the interface of the operating system is | 7 |
| well-recognized? | |
| Do you think that the operating system may provide personal | 7 |
| features? | |
| Does this operating system meet your needs? | 7 |
| Do you think that the patterns of the operating system are clear | 7 |
| presented? | |
| Do you think that the operating system provides more help than | 7 |
| other brands when you perform the operation? | |
| Do you think that the operating system benefits your efficiency | 7 |
| in comparison with other brands? | |
| Would you actually purchase the product of the operating system? | 7 |

Step S6: weighing and determining. The final step for weighing and determining comprises sub-step S61 (determining rule verifying and result, submit the determining rules according to the result), sub-step S62 (users' experience) and sub-step S63 (factors of users' characteristics and preferences). For sub-step S61 (determining rule verifying and result), a plurality of candidate rules may be produced from the training data set, as shown in Table 4.

TABLE 4

| | | | Number of | | | |
|---|---|---|---|---|---|---|
| | | Number of | samples | | | |
| | | samples | meeting the | | | |
| | | meeting the | condition and | | | |
| | | condition of | result of the | Confidence | Gain | Accepted |
| Rule | Candidate rules | the rule | rule | level | value | or not |
| 1 | If the user's personal | 14 | 14 | 100% | 3.59 | Yes |
| | aesthetics is high and the | | | | | |
| | operating system meets the | | | | | |
| | user's need, the user will | | | | | |
| | actually purchase the product | | | | | |
| | of the operating system. | | | | | |
| 2 | If the user's occupation | 13 | 13 | 100% | 3.59 | Yes |
| | belongs to the technology | | | | | |
| | industry and the operating | | | | | |
| | system meets the user's | | | | | |
| | need, the user will actually | | | | | |
| | purchase the product of the | | | | | |
| | operating system. | | | | | |
| 3 | If the user is easily attracted | 12 | 12 | 100% | 3.59 | Yes |
| | by 3C products and the | | | | | |
| | operating system holds high | | | | | |
| | response speed, the user will | | | | | |
| | actually purchase the product | | | | | |
| | of the operating system. | | | | | |
| 4 | If the user spends more than 6 | 11 | 11 | 100% | 3.59 | Yes |
| | hours per day on notebook/ | | | | | |
| | tablet on average, the user has | | | | | |
| | high aesthetic centrality and | | | | | |
| | the operating system holds a | | | | | |
| | good brand image, the user | | | | | |
| | will actually purchase the | | | | | |
| | product of the operating | | | | | |
| | system. | | | | | |
| 5 | If the user has high aesthetic | 11 | 11 | 100% | 3.59 | Yes |
| | centrality, the operating | | | | | |
| | system has simple operating | | | | | |
| | steps and the operating | | | | | |
| | system may provide personal | | | | | |
| | features, the user will actually | | | | | |
| | purchase the product of the | | | | | |
| | operating system. | | | | | |

The step of determining rule verifying and result may sift the foregoing principles from the training data set. The foregoing principles are partially abstracted and one may submit further candidate principles through different combinations. The rules concluded from the training data set may further be verified through the test data set. If there are confidence levels or gain values below the threshold in the test data set, the candidate principle would be removed. Sub-steps S62 (users' experience) and S63 (factors of users' characteristics and preferences) are concluded through the sifting process; wherein users' characteristics and preferences may be concluded as shown in Table 5:

TABLE 5

| | User's characteristics | | | | | | Factors of |
|---|---|---|---|---|---|---|---|
| | | | | | | Having | experience feeling |
| | User's | | Attracted | | Budget | purchase | Meeting |
| | personal | | by 3C | Monthly | per | requirement | the |
| Rule | aesthetics | occupation | products | income | year | of PC | requirement |
| 1 | high | — | — | — | — | — | Totally |
| | | | | | | | agree |
| 2 | — | Technology | — | — | — | — | Totally |
| | | industry | | | | | agree |
| 3 | — | — | high | — | — | — | — |
| 4 | high | — | — | — | — | — | — |
| 5 | — | — | — | 20~40 | — | — | — |
| | | | | thousands | | | |
| 6 | — | — | — | — | 30~50 | — | — |
| | | | | | thousands | | |

| | Factors of experience feeling | | | | | | Operating |
|---|---|---|---|---|---|---|---|
| | High | | Having | Little | | | system |
| | response | Simply | personal | energy | Beneficial | Purchase | meeting |
| Rule | speed | operated | features | consumed | operation | decision | the rules |
| 1 | — | — | — | — | — | Yes | iOS |
| 2 | — | — | — | — | — | Yes | iOS, |
| | | | | | | | Android |
| 3 | Totally | — | — | — | — | Yes | iOS |
| | agree | | | | | | |
| 4 | — | Totally | Totally | — | — | Yes | iOS, |
| | | agree | agree | | | | Android |
| 5 | — | — | — | Totally | — | Yes | iOS, |
| | | | | agree | | | Android |
| 6 | — | — | Totally | — | — | Yes | iOS |
| | | | agree | | | | |

The users' experience may be divided into one-dimension quality essentials, charisma quality essentials and necessary quality essentials. One-dimension quality essentials comprise that user pays much attention to personal features. If high one-dimension quality essentials are achieved, customers get great satisfaction. On the contrary, customers give negative appraisals for poor quality essentials. Charisma quality essentials comprise that user pays much attention to little consumed energy, satisfaction of users' requirement, high response speed and simple operating steps. Customers are not sensitive to low charisma quality essentials. However, as charisma quality essentials are enhanced, customers' satisfaction increases exponentially and the increasing range is much larger than that of one-dimension quality essentials. Necessary quality essentials comprise that the operation is beneficial. Necessary quality essentials are users' basic demand for products. Users' feeling of products would be very negative for poor necessary quality essentials.

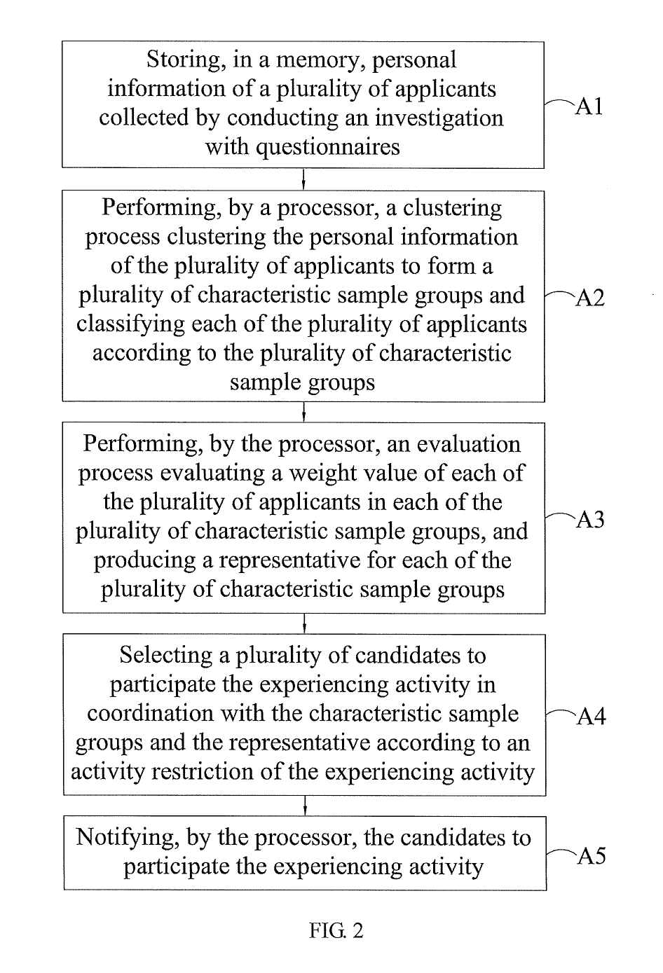

In the foregoing process, there are cost limitations and time limitations for planning and performing experiencing activities. Therefore, it is important to optimize the forgoing process such that the participants who participants the experiencing activities may effectively accomplish the product test so as to provide the final advice of determination. Referring to FIG. 2, which is the flow chart of the optimization method of matching a product experiencing activity with participants of an embodiment of the present disclosure. As shown in FIG. 2, the optimization method of the present embodiment comprises the following steps (A1˜5):

Step A1: storing, in a memory, personal information of a plurality of applicants collected by conducting an investigation with questionnaires. First, after defining the testing questions of the commercial electronic products, the questionnaires for participants may be designed according to the type of the products such that backgrounds and characteristics of the applicants who would like to participate the experiencing activity may be collected through the questionnaires. The questionnaire may comprise some related surveys such as the experience and habits of using commercial electron products in addition to some background surveys such as gender, age, occupation and education level. Besides, participants' characteristics such as moral character and aesthetic centrality may also be initially evaluated through the designed questions in the questionnaire. The survey result of the questionnaire may be transformed into quantitative characteristic values, classified according to degree and saved in a memory.

Step A2: performing, by a processor, a clustering process clustering the personal information of the plurality of applicants to form a plurality of characteristic sample groups and classifying each of the plurality of applicants according to the plurality of characteristic sample groups. According to the foregoing survey result of the questionnaire, the applicants may be classified into specific characteristic sample groups. The simplest way specifies male and female groups or groups of difference ages. In addition to the classification according to background information, one may classify various kinds of characteristic sample groups according to living habits and types such as senior citizen, retirement citizen, school-age parents, yettie, sport enthusiast, fashion trends enthusiast and healthy living citizen. The clustering process of the present embodiment may not set the type of the groups in advance. Make use of K-Means clustering algorithm for clustering the applicants. The characteristic sample groups are determined according to the clustering result and each applicant is classified into the corresponding group. K-Means clustering algorithm divides the information into K groups which do not cross each other. The prototype is classified into a group when more similarity exists between the prototype and the center of the group than that exists between the prototype and the center of other groups. Otherwise, classify the prototype into a new group, then, take the average value of the new group as the center and repeatedly calculate until the result converges such that big differences exist between different groups and small differences exist between difference information in each group. The clustering method used in the present embodiment is K-Means clustering algorithm. However, the present disclosure is not limited to this. Other clustering algorithms such as SOM algorithm may also be applied to the forgoing clustering process.

Step A3: performing, by the processor, an evaluation process evaluating a weight value of each of the plurality of applicants in each of the plurality of characteristic sample groups, and producing a representative for each of the plurality of characteristic sample groups. After the characteristic sample groups are determined, since the users classified into specific characteristic sample group are all of similar type, obtain approximate percentages of the representative according to the characteristics of the group in order to calculate related weight values and then select the representative of the characteristic sample group according to the weight values. The representative may be a set of a plurality of individuals as well, that is, recognize that the applicant belongs to the set of representatives of the characteristic sample group when the weight value is greater than the predetermined standard.

Step A4: selecting a plurality of candidates to participate the experiencing activity in coordination with the characteristic sample groups and the representative according to an activity restriction of the experiencing activity. Due to the considerations of time, site, space and cost of the foregoing experiencing activities, not all of the applicants who apply the experiencing activity may participate in the test. In order to take cost and efficiency into account, it is necessary to choose candidates who are most representative among the applicants. At present, the representative selected through the previous step may be the candidate suitable for participating the experiencing activity. Furthermore, in order to evenly choose different characteristic sample groups, the applicant simultaneously being the representatives of different characteristic sample groups may be classified according to the situation of other representatives of the same group. For example, an applicant who is simultaneously a sport enthusiast and a yettie may be classified as the representative of the yettie group when the sport enthusiast group has one or more representatives and the yettie group has none such that each characteristic sample group has at least one selected candidate for experiencing the activity.

Step A5: notifying, by the processor, the candidates to participate the experiencing activity. After the candidates who will actually participate in the experiencing activity are selected, transmit the list of qualified candidates and the process plan of the experiencing activity to the applicants such that the applicants may know whether they meet the qualifications of the experiencing activity. The system may also set applicants on the waiting list. When the selected candidates are unable to participate in the experiencing activity for some reasons, the applicants on the waiting list may be notified for making up the vacancies.

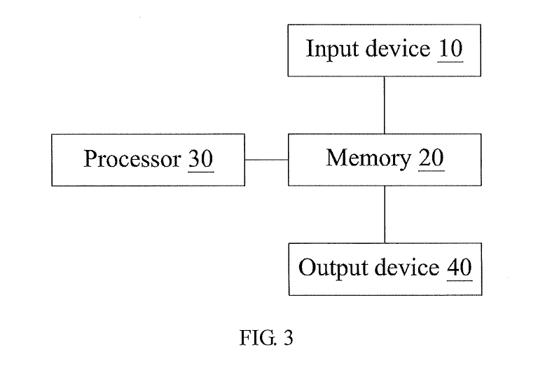

The foregoing method of matching a product experiencing activity with participants may be set in a specific system. Referring to FIG. 3, which is the block diagram of the system of matching a product experiencing activity with participants of an embodiment of the present disclosure. As shown in FIG.3, the system may comprise the input device 10, the memory 20, the processor 30 and the output device 40. Here, the input device 10 may comprise input interfaces such as touch panel, keyboard and mouse of electronic device comprising personal computer of the applicant, smart phone and server, etc. The applicant fills out the questionnaire of personal information on the website or page of the experiencing activity through the internet. After the applicant completes their personal information, the information is uploaded to and stored in the memory 20 through the wireless network transmission, wireless communication transmission or general wired internet. The memory 20 comprises read-only memory, flash memory, disk, or cloud database.

In addition, the system further comprises the processor 30 connecting to the memory 20. The processor 30 comprises central processing unit, microprocessor and the like. The processing program of the access memory proceeds with the clustering process, the evaluation process and the sifting process. The clustering process clusters the personal information filled out by the foregoing applicants, forms a plurality of characteristic sample groups and classifies the applicants into the characteristic sample groups respectively. The same applicant may be classified into multiple characteristic sample groups. The evaluation process evaluates weight value of the applicants in each characteristic sample group and determines a representative or a set of representatives of each characteristic sample group through the weight value. The sifting process selects the candidates to participate in the experiencing activity in coordination with each characteristic sample group and the corresponding representatives according to an activity restriction of the experiencing activity. The details of the above process are described by the reference to the previous embodiment, and the same technical features will not repeatedly be described.

When the processor 30 proceeds with the above process to get the result of candidates qualified for participating in the experiencing activity, the output device 40 may transmit the result to the applicants. For those who are eligible, the planned information of time, site and activity process of the experiencing activity may be attached to the transmitted result such that the candidates may make arrangements for participating in the activity. Finding the eligible candidates may reduce the number of people participating in the activity, but extend the range of characteristic sample types. That is, wider range of types of representatives is covered such that the experiencing activity may more effectively obtain experience feedback of the product and get the most evaluation benefits.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Although the terms first, second, third, etc. may be used herein to describe various elements, components, loops, circuits, and/or modules, these elements, components, loops, circuits, and/or modules should not be limited by these terms. These terms may be only used to distinguish one element, component, loop, circuit or module from another element, component, loop, circuit or module. Terms such as “first,” “second,” and other numerical terms when used herein do not imply a sequence or order unless clearly indicated by the context. Thus, a first element, component, loop, circuit or module discussed below could be termed a second element, component, loop, circuit or module without departing from the teachings of the example implementations disclosed herein.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The above description is merely illustrative and not restrictive. Any equivalent modification or change without departing from the spirit and scope of the present disclosure should be included in the appended claims.

What is claimed is:

1. An optimization method of matching a product experiencing activity with participants suitable for planning an experiencing activity for developing a new product, the method comprising the following steps:
storing, in a memory, personal information of a plurality of applicants collected by conducting an investigation with questionnaires;
performing, by a processor, a clustering process clustering the personal information of the plurality of applicants to form a plurality of characteristic sample groups and classifying each of the plurality of applicants according to the plurality of characteristic sample groups;
performing, by the processor, an evaluation process evaluating a weight value of each of the plurality of applicants in each of the plurality of characteristic sample groups, and producing a representative for each of the plurality of characteristic sample groups in accordance with the weight values;
performing, by the processor, a sifting process selecting a plurality of candidates to participate the experiencing activity in coordination with the characteristic sample groups and the representative according to an activity restriction of the experiencing activity; and
notifying, by the processor, the candidates to participate the experiencing activity.

2. The optimization method of claim 1, wherein the personal information comprises background information, lifestyle or aptitude surveys of the plurality of applicants.

3. The optimization method of claim 1, wherein the clustering process makes use of K-Means clustering algorithm to cluster the personal information.

4. The optimization method of claim 1, wherein the evaluation process computes the degree of correlation between the personal information of the plurality of applicants and characteristics defined in the characteristic sample groups in order to provide the corresponding weight values.

5. The optimization method of claim 1, wherein the activity restriction includes the number of the participants who experience the experiencing activity, the duration of the experiencing activity, the site of the experiencing activity and the cost of the experiencing activity.

6. A system of matching a product experiencing activity with participants suitable for planning an experiencing activity for developing a new product, the system comprising:
an input interface collecting personal information of a plurality of applicants investigated with questionnaires;
a memory connecting to the input interface and storing the personal information;
a processor connecting to the memory and accessing the memory to conduct the following processes:
a clustering process clustering the personal information of the plurality of applicants, forming a plurality of characteristic sample groups and classifying each of the plurality of applicants according to the plurality of characteristic sample groups;
an evaluation process evaluating a weight value of each of the plurality of applicants in each of the plurality of characteristic sample groups and producing a representative for each of the plurality of characteristic sample groups in accordance with the weight values; and
a sifting process selecting a plurality of candidates to participate the experiencing activity in coordination with the characteristic sample groups and the representative according to an activity restriction of the experiencing activity; and
an output interface outputting the matching result of the plurality of applicants.

7. The system of claim 6, wherein the personal information comprises background information, lifestyle or aptitude surveys of the plurality of applicants.

8. The system of claim 6, wherein the clustering process makes use of K-Means clustering algorithm to cluster the personal information.

9. The system of claim 6, wherein the evaluation process computes the degree of correlation between the personal information of the plurality of applicants and characteristics defined in the characteristic sample groups in order to provide the corresponding weight value.

10. The system of claim 6, wherein the activity restriction includes the number of the participants who experience the experiencing activity, the duration of the experiencing activity, the site of the experiencing activity and the cost of the experiencing activity.
